(19) United States
(12) Patent Application Publication
(10) Pub. No.: US 2006/0224626 A1
(43) Pub. Date: Oct. 5, 2006

(54) Versioned file group repository

(76) Inventors: Anand Lakshminath, Fremont, CA (US); Benny Souder, Belmont, CA (US); James W. Stamos, Saratoga, CA (US); Lik Wong, Union City, CA (US); Hung Tran, Belmont, CA (US)

Correspondence Address: HICKMAN PALERMO TRUONG & BECKER/ORACLE, 2055 GATEWAY PLACE, SUITE 550, SAN JOSE, CA, 95110-1089, US

(21) Appl. No.: 11/099,203

(22) Filed: Apr. 4, 2005

(51) Int. Cl. G06F 17/00

(52) U.S. Cl. 707/104.1

(57) ABSTRACT

Techniques are provided for managing electronic items by storing, within a file group repository, metadata that identifies (a) a plurality of file groups, (b) for each file group, a set of one or more file group versions for the file group, and (c) for each file group version of each file group, a set of one or more items that belong to the version of the file group. Once the metadata has been established, queries may be executed against the metadata to request identification of items that belong to a particular version of a particular file group. This file group framework may be used in a variety of contexts, including the management of a centralized tablespace repository, and periodic purging of versions of file collections, where the files within the collections may be spread across multiple repositories.

### FIELD OF THE INVENTION

The present invention relates to repositories and, more specifically, to a versioned tablespace repository.

### BACKGROUND

From the perspective of a file system, the data stored within a database resides in datafiles. A tablespace is a collection of one or more datafiles. Tablespaces function as a unit of object placement, space administration, and point-in-time recovery. Every datafile within a database belongs to exactly one tablespace, and whenever a new datafile is added to a database, it is always added to a specific tablespace.

A pluggable tablespace is a tablespace that can be transferred from one database to another database. The transfer operation may involve, for example, storing disk pointers contained by the tablespace in a tablespace-relative format. In one implementation, the tablespace is unplugged from one database by saving metadata associated with the tablespace and by making a binary copy of the tablespace and the saved metadata. The tablespace is plugged into another database by making the binary copy accessible to a computer system of the other database, incorporating the saved metadata, and locating a data item associated with any one of the disk pointers without patching the disk pointers.

Various techniques for implementing and using pluggable tablespaces are described in U.S. Pat. No. 5,890,167, U.S. Pat. No. 5,873,102, and U.S. Pat. No. 6,804,671, the entire contents of each of which are incorporated herein by reference.

Pluggable tablespaces may be used in a variety of contexts. For example, in a grid environment, a node within the grid may require access to a snapshot or version of a given pluggable tablespace. The appropriate version of the pluggable tablespace may be provided to the node by unplugging the tablespace from where the tablespace currently resides, and plugging the tablespace in to a database managed by the node the needs to see the tablespace.

Pluggable tablespaces are merely one example of items (1) whose contents may change from version to version, and (2) that may need to be moved, retrieved and/or copied on a version-by-version basis. It is desirable to facilitate the movement, retrieval and copy operations that need to be performed on such items.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a file group repository according to an embodiment of the invention;

FIG. 2 is a block diagram that illustrates relationships between file groups, file group versions, and items, that may be reflected in the metadata contained in the file group repository illustrated in FIG. 1; and

FIG. 3 is a block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### FILE GROUP REPOSITORY

A file group repository is a repository that stores metadata about the relationships between items, and provides a mechanism to perform operations on those items based on those relationships. The nature of the items managed by a file group repository may vary from implementation to implementation. For example, the items may be specific types of files, such as tablespace datafiles. The items themselves may be stored in the file group repository, or external to the file group repository.

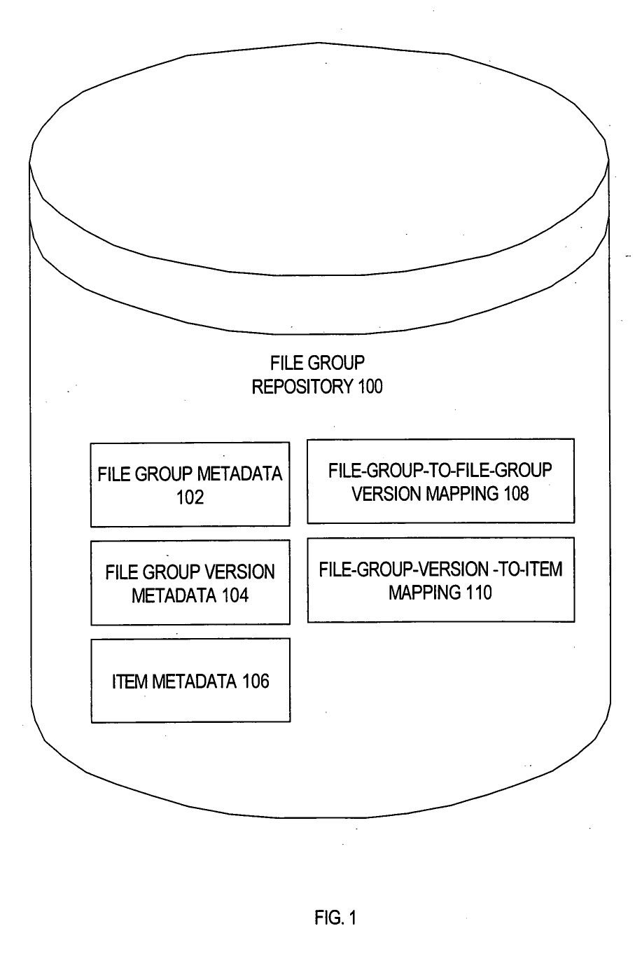

Referring to FIG. 1, it is a block diagram that illustrates the various types of information that may be maintained by a file group repository 100. In the illustrated embodiment, the file group repository 100 stores item metadata 106 that identifies the items managed by the file group repository 100. According to one embodiment, within the item metadata 106, items are identified using “item identifiers”. In an embodiment where the items are files, the item identifiers may be, for example, pointers that specify (1) a file name, (2) a directory object, and (3) a file type. For example, a pointer may have the form “/net/dlsun111/dba/rdbms/dbs/data.f”.

The file group repository facilitates the retrieval, copying and movement of items on a version-by-version basis. According to one embodiment, in addition to the item metadata 106, the file group repository 100 stores file group metadata 102, a file-group-to-file-group-version mapping 108, file group version metadata 104, and a file-group-version-to-item mapping 110. Each of these types of metadata shall be described in greater detail hereafter.

### FILE GROUP VERSIONS

A file group version is a collection of related items. The file group version metadata 104 includes data that identifies such item collections. The file-group-version-to-item mapping 110 maps each file group version to the items that belong to the file group version. For example, file group version metadata 104 may define a file group version FGV1, item metadata 106 may include item identifiers IID1 and IID2, and file-group-version-to-item mapping 110 may include data that maps FGV1 to item identifiers IID1 and IID2. The mapping of FGV1 to IID1 and IID2 establishes the items associated with IID1 and IID2 as members of the file group version FGV1.

The actual relationship between the items that belong to a file group version may vary from implementation to implementation. For example, in an embodiment where the file group repository is used to manage tablespaces, a file group version may correspond to a snapshot of a particular tablespace. Under these circumstances, each file group version may be mapped to the set of datafiles and the datapump transportable tablespace export dump file that belong to a particular snapshot of a particular tablespace.

### FILE GROUPS

A file group is a collection of related file group versions. The file group metadata 102 includes metadata that identifies such collections of file group versions. The file-group-to-file-group-version mapping 108 maps file groups to the file group versions that belong to the file group. In an embodiment where the file group repository is used to manage tablespaces, a file group may correspond to a tablespace set. In such an embodiment, the file-group-to-file-group-version mapping 108 may map the file group that corresponds to a particular tablespace set to the file group versions that correspond to different snapshots of that particular tablespace set. For example, a “financial quarters” file group may be mapped to file group versions that correspond to tablespaces containing quarterly financial data.

As another example, each file group may correspond to a particular tablespace. At different points in time, a “snapshot” can be taken of the particular tablespace. For each such snapshot, a file group version would be created. The file group version for each snapshot would be mapped to the items that belonged to the particular tablespace at the time that the snapshot was taken.

### EXAMPLE REPOSITORY

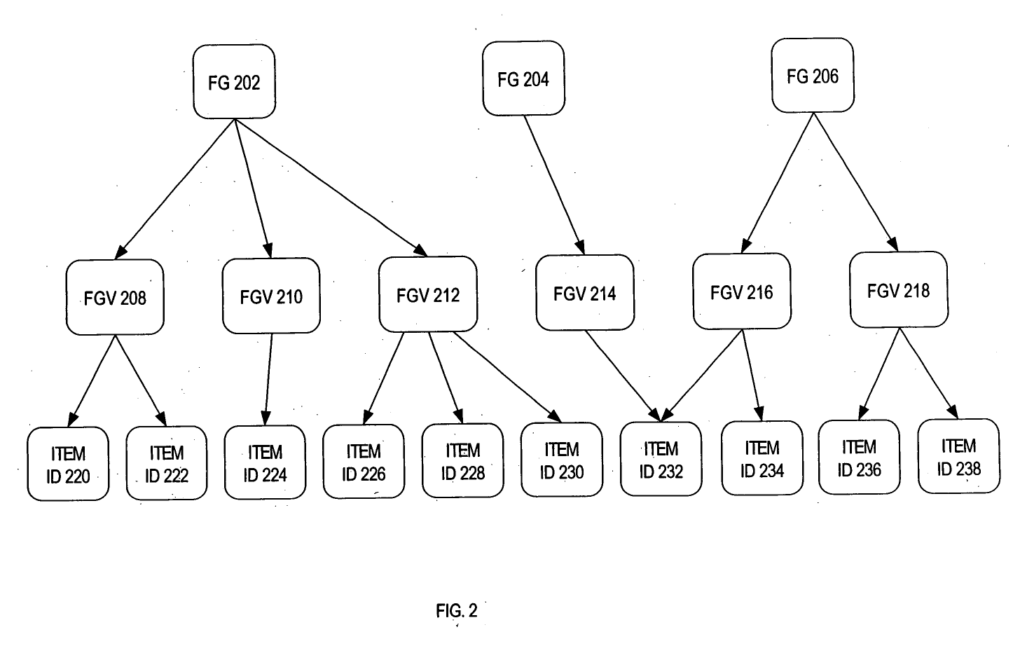

FIG. 2 is a block diagram that gives an example of the information that may be reflected in the metadata maintained by the file group repository 100. Referring to FIG. 2, it illustrates three file groups 202, 204 and 206. Information that defines each of these file groups may be stored within file group metadata 102.

Also shown in FIG. 2 are several file group versions 208-218, and several item identifiers 220-238. Information that defines each of the file group versions may be stored in file group version metadata 104. Information that defines each of the item identifiers may be stored within item metadata 106.

The mapping between file groups and file group versions is stored in file-group-to-file-group-version mapping 108. Specifically, to reflect the relationships illustrated in FIG. 2, file-group-to-file-group-version mapping 108 would include metadata that maps file group 202 to file group versions 208, 210 and 212. File group 204 would be mapped to file group version 214. File group 206 would be mapped to file group versions 216 and 218.

The mapping between file group versions and items is stored in file-group-version-to-item mapping 110. As illustrated in FIG. 2, a single item (e.g. item 232) can belong to multiple versions, which may or may not belong to the same file group. To reflect the relationships illustrated in FIG. 2, the file-group-version-to-item mapping 110 would include metadata that maps file group version 208 to item identifiers 220 and 222. File group version 210 would be mapped to item identifier 224. File group version 212 would be mapped to item identifiers 226, 228 and 230. File group version 214 would be mapped to item identifier 232. File group version 216 would be mapped to item identifiers 232 and 234. File group version 218 would be mapped to item identifiers 236 and 238.

The files that belong to different versions of the same file group need not be different versions of the same files. For example, item identifier 224 may represent a file that is completely different than the files associated with item identifiers 220 and 222, even though the item identifiers 220, 222 and 224 descend from different versions of the same file group 202. Thus, file group 202 may correspond to financial quarters. File group version 208 may correspond to QI of 2004, and file group version 210 may correspond to Q2 of 2004. Item identifier 220 may correspond to a particular spreadsheet of sales in Q1 of 2004, while item identifier 222 may correspond to a particular text document describing purchases in Q1 of 2004. Item identifier 224 may correspond to a file that has nothing to do with that particular spreadsheet or that particular text document. For example, item identifier 224 may correspond to an export dump file made during Q2 of 2004.

### SUPPLEMENTAL METADATA

As mentioned above, file group metadata 102 identifies file groups, file group version metadata 104 identifies file group versions, and item metadata 106 identifies items. However, each of these sets of metadata may be supplemented with additional information about the entities identified therein. For example, for each file group identified in file group metadata 102, file group metadata 102 may include information about the thing that is represented by the file group. In an embodiment where the file groups correspond to tablespaces, the file group metadata 102 may include information about the tablespaces, such as when they were created, who owns them, etc.

Similarly, for each file group version identified in file group version metadata 104, file group version metadata 104 may include information about the thing that is represented by the file group version. In an embodiment where the file group versions correspond to versions of tablespaces, the file group version metadata 104 may include information about the tablespace versions, such as the time at which the version's snapshot was taken, what tables are contained in the tablespace version, what schemas are in the tablespace version, etc.

Likewise, for each item identifier in item metadata 106, item metadata 106 may include information about the item that is represented by the item identifier. In an embodiment where the items are files, the item metadata 106 may include information about the files, such as the creation time of the file, the last modification time of the file, the owner of the file, etc.

### MECHANISMS FOR ADDING SUPPLEMENTAL METADATA

The supplemental metadata described above may be added to the file group repository 100 in a variety of ways. For example, according to one embodiment, the file group repository includes a mechanism by which a user may submit name/value pairs for any entity (e.g. any file group, file group version, or item) represented in the file group repository. For example, for a particular item identifier II5, a user may submit the name/value pair: owner/“John”. The file group repository 100 would then store the name value pair in association with the item identifier II5. Consequently, if a user subsequently submits a query with the predicate “where owner=‘John’”, the file identifier II5 would be included in the result set of the query.

Instead of or in addition to such user-provided supplemental metadata, file group repository 100 may include a mechanism to automatically extract and store certain pieces of information about certain types of entities. For example, in an embodiment where file group versions represent versions of tablespaces, the creation of a new file group version may cause the file group repository to automatically (1) scan the corresponding tablespace, (2) determine the tables that belong to the tablespace, and (3) store in the file group version metadata 104 information about which tables belong to the version of the tablespace associated with the newly created file group version.

This is merely one example of an automated metadata extraction operation that can be performed by the file group repository 100. The actual information that is automatically extracted and stored as supplemental metadata will vary from implementation to implementation, and will typically depend on the type of entities that are represented as file groups, file group versions, and items, within the file group repository 100. For example, if the items are digital photographs, the automatically extracted metadata may include the resolution of the photographs, whether the photographs are color or black and white, the encoding format of the photographs, etc.

The automatically extracted supplemental metadata may be stored in the same manner as user-provided supplemental metadata. For example, if the user-provided supplemental metadata is stored in the form of name/value pairs, then the automatically extracted supplemental metadata may also be stored in the form of name/value pairs. Consequently, the manner in which the supplemental metadata was created need not affect the form of queries executed against the supplemental metadata.

According to one embodiment, file group repository 100 maintains the metadata in the form of XML documents. Storing the metadata in the form of XML documents facilitates accessing the data using XQuery or XQueryX commands. As shall be described in greater detail hereafter, support of XQuery and XQueryX commands may be provided using hooks to an XDB repository without having to actually store the metadata in an XDB repository.

### FILE GROUP REPOSITORY OPERATIONS

According to one embodiment, the file group repository includes routines to perform the following operations:
create/alter/drop file groups
create/alter/drop versions for a file group
specify retention time for purging versions and also min/max versions for the file group
support auto purge of versions using a background job
add/alter/remove item from a version
access control for file groups/versions/items.
catalog to query file groups, versions and items.
catalog to query tables and tablespaces contained in a specific version, if applicable.

In one embodiment, the file group repository exposes an API that allows external computer programs to invoke the routines to perform these operations. Instead of or in addition to such an API, the metadata maintained in the file group repository may be accessed through SQL commands and/or XDB commands.

With respect to SQL access, the metadata of the file group repository may be stored in tables within a relational database. Thus stored, SQL commands may be submitted to the database server that manages the database to retrieve and manipulate data in those tables. For example, in a context in which the file groups represent tablespaces, a user may submit a query against the tables to retrieve information about all of the versions of a particular tablespace. The user may then decide which version is of interest, and submit a subsequent query to retrieve the item identifiers that are mapped to the file group version that represents the tablespace version of interest.

### AUTO-PURGING

According to one embodiment, a version creation time is stored with each file group version. A background purging process may periodically retrieve the version creation times associated with the file group versions in the file group repository, and submit commands to delete all file group versions (and associated file identifiers) that have a version creation time that is older than some predetermined threshold.

In one embodiment, the purging mechanism supports an option to delete the actual items that belong to the file group versions that are being purged. For example, assume that file group version 208 is to be purged, and the user has specified the “delete item” option. Under these circumstances, the file group repository 100 would delete all metadata associated with file group version 208, all metadata associated with item identifiers 220 and 222, and would cause the items identified by item identifiers 220 and 222 to be deleted. In a context were items are files, the file group repository 100 may, for example, send commands to a file system to cause the files identified by item identifiers 220 and 222 to be deleted.

As mentioned above, the actual items that belong to file group versions may not reside in the system hosting the file group repository 100 itself. In fact, a single file group version may include items that reside in many distinct locations. For example, a file group version may include a file that is managed by a file system, a table that resides in a first database, and an XML document that resides in another database. By implementing a retention policy using file group repository 100, the retention policy is insulated from the specific systems in which the items reside. Due to this insulation, an item may be moved from one database to another, for example, without affecting the time at which the item will be purged.

### INDIRECT ACCESS THROUGH XDB

An XDB repository is a repository designed for accessing and managing XML data. Oracle XML database is an example of a popular XDB repository. Details about the Oracle XML database may be found at www.oracle.com/technology/tech/xml/xmldb/index.html.

According to one embodiment, the metadata maintained by the file group repository 100 is maintained in the form of XML data that may be accessed indirectly through an XDB repository. For example, the file group repository 100 may create “virtual nodes” in an XDB repository, and establish hooks from the XDB repository back to the file group repository 100. The virtual nodes correspond to pieces of metadata maintained by the file group repository 100 external to the XDB repository.

When a user submits a query against the virtual nodes, the XDB repository uses the hooks to perform a call-back operation to the file group repository 100. In the call back, the XDB repository indicates the virtual node against which the query is being performed. The file group repository 100 determines which metadata is associated with the virtual node, and responds appropriately to the requested operation.

XDB repositories support a variety of operations. By exposing the metadata of the file group repository 100 through the XDB repository, the same variety of operations may then be performed on the metadata of the file group repository 100. For example, the requested operation may be an FTP operation to retrieve the metadata associated with a particular virtual node. In response, the file group repository 100 may perform the FTP operation to send the corresponding metadata to the entity that sent the FTP request to the XDB repository.

By establishing hooks between the file group repository 100 to the XDB repository, a user of the XDB repository may also indirectly operate on items that are identified by item identifiers, even though the items themselves may not reside in either the XDB repository or the file group repository. For example, assume that a user performs an FTP operation against a virtual node that corresponds to an item identifier. In response, the XDB repository calls the file group repository 100, and the file group repository 100 locates the appropriate item identifier. Based on the information in the item identifier, the file group repository 100 is able to locate the corresponding item, and cause the requested operation to be performed on the item. For example, the item may be stored in a relational database. The file group repository may send a call to the database server that manages the database to have the database server perform an FTP operation using the item.

### VERSIONED TABLESPACE REPOSITORY

According to one embodiment, the file group repository 100 is used by a versioned tablespace repository to handle the movement of pluggable tablespaces between databases managed by a grid of nodes. According to one embodiment, the versioned tablespace repository uses the file group repository 100 to keep track of which files belong to which versions of which tablespaces. With this knowledge, the versioned tablespace repository is able to perform the following operations:
clone or copy a tablespace version to a central repository
detach or move a tablespace version to a central repository
attach or plug-in a tablespace version from a central repository
automatic purging of tablespace versions based on version creation time
query contents of any given tablespace version

For example, the versioned tablespace repository may call the routines exposed by the file group repository to create a file group for each tablespace, create a file group version for each version of the tablespace, and add the appropriate files to each file group version. Once the appropriate metadata has been created within file group repository 100, the versioned tablespace repository is able to query the file group repository 100 to determine which files belong to a particular version of a particular tablespace. Based on this information, the versioned tablespace repository may execute the desired tablespace operation.

For example, assume that a routine in the versioned tablespace repository has been called to move version 2 of a tablespace X from a database Z to a central repository. To determine the files that belong to version 2 of tablespace X, the versioned tablespace repository calls a routine exposed by the file group repository 100. The call requests the items that are mapped to the file group version associated with version 2 of tablespace X. In response, the file group repository returns the item identifiers to which the specified file group version is mapped. As mentioned above, each such item identifier may specify, for example, a directory object and file name for the items. Based on the file identifiers, the versioned tablespace repository knows which specific files must be moved to move version 2 of tablespace X. The versioned tablespace repository may then move those files to the central repository, and send calls to the file group repository 100 to change the item identifiers for those moved items to reflect the new location of the items.

The versioned tablespace repository may be configured to create a new version of a tablespace (1) periodically, (2) on demand, or (3) automatically in response to the occurrence of a particular event. To create a new version of tablespace, the versioned tablespace repository makes a call to the file group repository 100 to create new file group version. The new file group version is mapped to the file group that represents the tablespace. The versioned tablespace repository determines the items that belong to the current snapshot of the tablespace. The versioned tablespace repository then makes calls to the file group repository 100 to (1) create item identifiers for the items that belong to the current snapshot of the database, and (2) create a mapping between the new file group version and those file identifiers.

A versioned tablespace repository is useful in a variety of applications. For example, the services provided by such a versioned tablespace repository could be used, among other things, for data migration, data warehousing, backup and recovery and load balancing.

### HARDWARE OVERVIEW

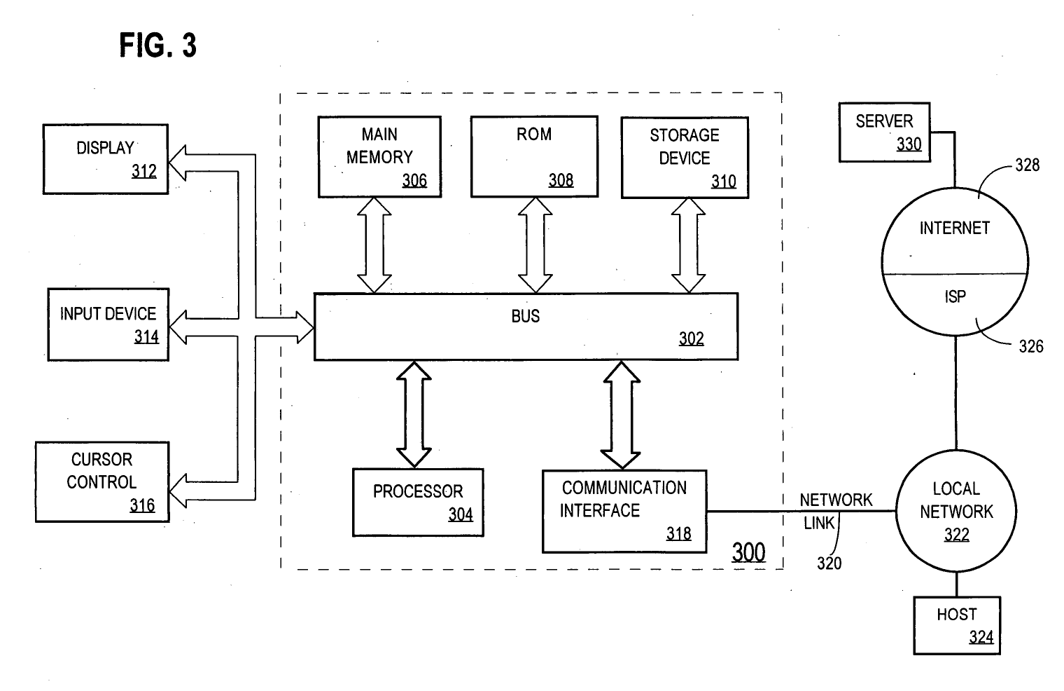

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for managing electronic items, the method comprising:
storing, within a repository, metadata that identifies
(a) a plurality of file groups;
(b) for each file group, a set of one or more file group versions for the file group; and
(c) for each file group version of each file group, a set of one or more items that belong to the version of the file group;
receiving a request that requires identification of items that belong to a particular version of a particular file group; and
in response to the request, determining the items that belong to the particular version of the particular file group based on the metadata within said repository.

2. The method of claim 1 further comprising:
receiving a request to create a new entity within the repository, wherein the new entity is one of a file group, a file group version, and an item identifier;
in response to the request, performing the steps of
inspecting one or more files associated with the new entity;
generating supplemental metadata based on the one or more files;
storing the supplemental metadata in the repository in association with the new entity.

3. The method of claim 2 further comprising:
receiving a query; and
determining a result set for said query based, in part, on the supplemental metadata stored in the repository.

4. The method of claim 1 wherein:
each file group corresponds to a tablespace;
the file group versions of a file group correspond to snapshots of the tablespace associated with the file group; and
the items for a file group version are files associated with the tablespace snapshot represented by the file group version.

5. The method of claim 4 further comprising:
receiving a request to move a particular version of a particular tablespace from a first location to a second location;
in response to the request, accessing the metadata in the repository to determine information about the particular version of the particular tablespace; and
moving the particular version of the particular tablespace from the first location to the second location based on the information about the particular version of the particular tablespace.

6. The method of claim 5 wherein the information about the particular version of the particular tablespace includes data that identifies files associated with the particular version of the particular tablespace.

7. The method of claim 5 wherein the step of moving the particular version of the particular tablespace from the first location to the second location includes moving the particular version of the particular tablespace from a central repository to a location accessible to a particular node of a grid.

8. The method of claim 5 wherein the step of moving the particular version of the particular tablespace from the first location to the second location includes moving the particular version of the particular tablespace from a location accessible to a particular node of a grid to a central repository.

9. The method of claim 5 wherein the step of moving the particular version of the particular tablespace from the first location to the second location includes moving the particular version of the particular tablespace from a location accessible to a first node of a grid to a location accessible to a second node of the grid.

10. The method of claim 2 wherein the supplemental metadata is stored within the repository in the form of name/value pairs.

11. The method of claim 2 wherein the supplemental metadata is stored within the repository in the form of XML data.

12. The method of claim 1 wherein:
at least some of the metadata stored in the repository is stored in the form of XML data; and
the method further comprises executing XQuery commands submitted against the XML data.

13. The method of claim 1, wherein at least some of the metadata stored in the repository is stored in the form of XML data, the method further comprising:
representing the XML data as virtual nodes within an XDB database; and
using the XML data in the repository to answer requests, submitted to the XDB database, that involve said virtual nodes.

14. The method of claim 1 further comprising:
receiving user specified information about an entity within the repository, wherein the entity is one of a file group, a file group version, and an item identifier;
storing the user specified information, within said repository, as supplemental metadata associated with said entity;
receiving a query; and
determining a result set for said query based, in part, on the supplemental metadata stored in the repository.

15. The method of claim 1 further comprising automatically purging file group versions that are older than a predetermined age.

16. The method of claim 15 wherein the step of automatically purging is performed by deleting the metadata associated with the file group versions and the items that belong to the file group versions, without deleting the items represented in the deleted metadata.

17. The method of claim 15 wherein the step of automatically purging is performed by both (a) deleting the metadata associated with the file group versions and the items that belong to the file group versions, and (b) deleting the items represented in the deleted metadata.

18. A computer-readable medium carrying one or more sequences of instructions which, when executed by one or more processors, causes the one or more processors to perform the method recited in claim 1.

19. A computer-readable medium carrying one or more sequences of instructions which, when executed by one or more processors, causes the one or more processors to perform the method recited in claim 2.

20. A computer-readable medium carrying one or more sequences of instructions which, when executed by one or more processors, causes the one or more processors to perform the method recited in claim 3.

21. A computer-readable medium carrying one or more sequences of instructions which, when executed by one or more processors, causes the one or more processors to perform the method recited in claim 4.

22. A computer-readable medium carrying one or more sequences of instructions which, when executed by one or more processors, causes the one or more processors to perform the method recited in claim 5.

23. A computer-readable medium carrying one or more sequences of instructions which, when executed by one or more processors, causes the one or more processors to perform the method recited in claim 6.

24. A computer-readable medium carrying one or more sequences of instructions which, when executed by one or more processors, causes the one or more processors to perform the method recited in claim 7.

25. A computer-readable medium carrying one or more sequences of instructions which, when executed by one or more processors, causes the one or more processors to perform the method recited in claim 8.

26. A computer-readable medium carrying one or more sequences of instructions which, when executed by one or more processors, causes the one or more processors to perform the method recited in claim 9.

27. A computer-readable medium carrying one or more sequences of instructions which, when executed by one or more processors, causes the one or more processors to perform the method recited in claim 10.

28. A computer-readable medium carrying one or more sequences of instructions which, when executed by one or more processors, causes the one or more processors to perform the method recited in claim 11.

29. A computer-readable medium carrying one or more sequences of instructions which, when executed by one or more processors, causes the one or more processors to perform the method recited in claim 12.

30. A computer-readable medium carrying one or more sequences of instructions which, when executed by one or more processors, causes the one or more processors to perform the method recited in claim 13.

31. A computer-readable medium carrying one or more sequences of instructions which, when executed by one or more processors, causes the one or more processors to perform the method recited in claim 14.

32. A computer-readable medium carrying one or more sequences of instructions which, when executed by one or more processors, causes the one or more processors to perform the method recited in claim 15.

33. A computer-readable medium carrying one or more sequences of instructions which, when executed by one or more processors, causes the one or more processors to perform the method recited in claim 16.

34. A computer-readable medium carrying one or more sequences of instructions which, when executed by one or more processors, causes the one or more processors to perform the method recited in claim 17.
